(19) United States
(12) Patent Application Publication
(10) Pub. No.: US 2023/0302549 A1
(43) Pub. Date: Sep. 28, 2023

(54) QUICK CLAMPING FIXTURE FOR POCKET HOLE JIG

(71) Applicant: Yingshen Liu, Qingdao (CN)

(72) Inventor: Yingshen Liu, Qingdao (CN)

(21) Appl. No.: 17/700,502

(22) Filed: Mar. 22, 2022

(51) Int. Cl. B23B 47/28

(52) U.S. Cl. CPC B23B 47/28; B23B 2247/12

(57) ABSTRACT

Disclosed is a quick clamping fixture for a pocket hole jig, which comprises a base, a clamping block slidably arranged above the base and a locking mechanism for locking the clamping block from free sliding, wherein one side of the base is provided with a back plate, and the clamping block is provided with an accommodating cavity for accommodating the pocket hole jig, and the clamping block slides to clamp wood boards with different thicknesses between the back plate and the pocket hole jig; the pocket hole jig is installed on the clamping block. During working, the pocket hole jig and the locking mechanism are located on the same side of the wood board, which can quickly realize the clamping, punching and disassembling of the wood board.

### TECHNICAL FIELD

The present utility model relates to a quick clamping fixture for a pocket hole jig.

### BACKGROUND

A pocket hole jig is a fixture used to drill pocket holes on wooden boards. In order to improve drilling efficiency, a pocket hole jig is generally equipped with a special locator to realize the function of quick clamping. When an existing positioner is in use, the position of the pocket hole jig is generally fixed, and the clamping of the wood board is realized by the relative movement of the clamping block, that is, when the wood board is clamped, the pocket hole jig and the clamping block are respectively located at the two sides of the wood board, and the clamping operation needs to be carried out on the other side after the pocket hole is drilled on one side of the wood board, which is inconvenient to operate; for example, in the present utility model patent with the application number of 201820056405.0, the main board 4 and the clamping head 21 are respectively located on both sides of the wood board when in use, which is precisely above situation.

### SUMMARY

In view of the shortcomings in the above problems, the present utility model provides a quick clamping fixture for a pocket hole jig.

In order to achieve the above purpose, the present utility model provides a quick clamping fixture for a pocket hole jig, which includes a base, a clamping block slidably arranged above the base and a locking mechanism for locking the clamping block from free sliding, wherein one side of the base is provided with a back plate, and the clamping block is provided with an accommodating cavity for accommodating the pocket hole jig, and the clamping block slides to clamp wood boards with different thicknesses between the back plate and the pocket hole jig;

the pocket hole jig is installed on the clamping block and during working, the pocket hole jig and the locking mechanism are located on the same side of the wood board, which can quickly realize the clamping, punching and disassembling of the wood board.

As a further improvement of the solution, the back plate and the base are integrally formed, and the acting surface of the back plate is coated with a rubber pad;

in the technical solution, the integrally formed rubber pad has strong overall feeling, and the rubber pad plays a role in reducing wear, and at the same time, the clamping is more stable.

As a further improvement of the solution, the height of the pocket hole jig in the accommodating cavity can be adjusted, and the acting surface of the pocket hole jig is flush with the side surface of the clamping block, or the acting surface of the pocket hole jig protrudes from the side surface of the clamping block.

In the above technical solution, the height-adjustable design enhances the versatility, and the pocket hole jig should be at least flush with the clamping block to ensure that the pocket hole jig plays a role.

As a further improvement of the solution, the panel of the clamping block is provided with a plurality of long waist-shaped through holes, and the clamping block is connected with a dust hood at the rear side of the through holes, and the dust hood can be externally connected with a vacuumizing device;

In the above technical solution, through the configuration of the dust hood and the vacuum pumping device, it is convenient for the rapid discharge of waste materials in the process of drilling pocket holes.

As a further improvement of the solution, the clamping block is also fixedly connected with a handle, the handle is connected with the clamping block in a clamping manner, and a hole into which the dust hood extends is formed between the handle and the clamping block, and the dust hood is locked by a fastener after extending into the hole;

In the technical solution, the clamping method is simple to assemble, and the installation of the dust hood is also very convenient.

As a further improvement of the solution, the locking mechanism includes a locking lever fixed in the middle of the base, and a first trigger and a second trigger which interact with the locking lever to realize opening and closing;

In the technical solution, the first trigger and the second trigger can limit the clamping block.

As a further improvement of the solution, it also comprises a fixing mechanism for fixing the base on a workbench, wherein the fixing mechanism includes a post connected with the base, a bottom block which can be elevatably arranged on the pillar, and a locking knob arranged on the bottom block;

In the technical solution, the position is properly adjusted by the fixing mechanism, so that it is suitable for clamping with different worktable thicknesses while being fixed on the worktable.

Compared with the prior art, the present utility model has the following beneficial effects: the quick clamping fixture is ingenious in structural design and convenient to assemble; the pocket hole jig is installed on the clamping block; when working, the pocket hole jig and the locking mechanism are located at the same side of the wood board, so that clamping, punching and disassembling of the wood board can be quickly realized, and the working efficiency is greatly improved

### BRIEF DESCRIPTION OF DRAWINGS

FIG. 1 is a perspective view of a quick clamping fixture for a pocket hole jig of the present utility model;

FIG. 2 is an explosion diagram of a quick clamping fixture for a pocket hole jig of the present utility model.

In the figures: 1. Locking knob; 2. Post; 3. Bottom block; 4. Base; 41. Back plate; 5. Locking lever; 6. Handle; 7. First trigger; 8. Second trigger; 9. Dust hood; 10. Clamping block; 101, Accommodating cavity; 102. Through hole; 11. Pocket hole jig.

### DESCRIPTION OF EMBODIMENTS

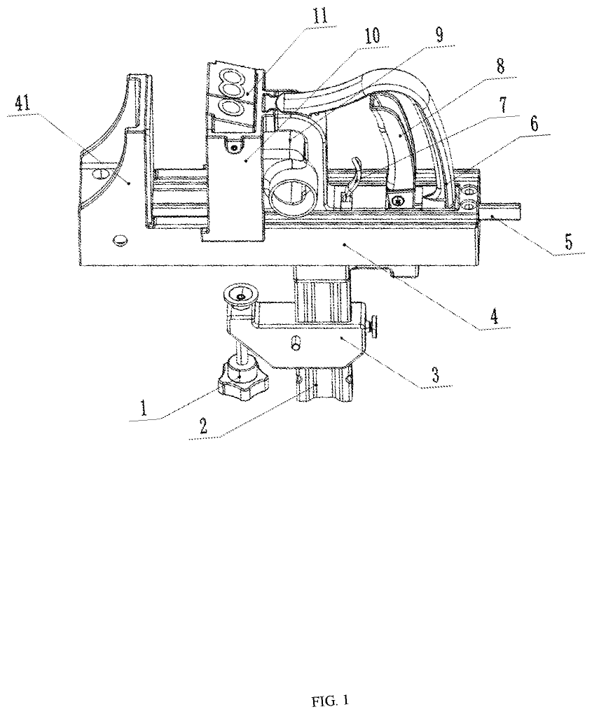

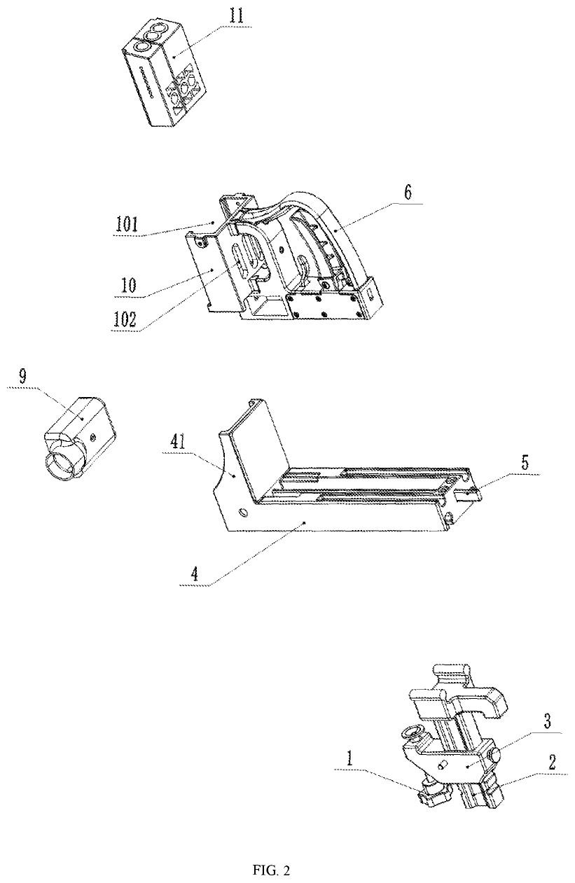

As shown in FIG. 1 and FIG. 2, a quick clamping fixture for a pocket hole jig in this embodiment of the present utility model includes a base 4, a clamping block 10 slidably arranged above the base 4 and a locking mechanism for locking the clamping block 10 from free sliding. One side of the base 4 is provided with a back plate 41, and the clamping block 10 is provided with an accommodating cavity 101 for accommodating the pocket hole jig 11. The clamping block 10 slides to clamp wood boards with different thicknesses between the back plate 41 and the pocket hole jig 11. Wherein, the backup plate 41 is integrally formed with the base 4, and the acting surface of the backup plate 41 is coated with a rubber pad, which has a strong sense of integration, and the rubber pad plays a role in reducing wear and makes the clamping more stable. The height of the pocket hole jig 11 in the accommodating cavity 101 is adjustable, and the acting surface of the pocket hole jig 11 is flush with the side surface of the clamping block 10, or the acting surface of the pocket hole jig 11 protrudes from the side surface of the clamping block 101. The height-adjustable design enhances versatility, and the pocket hole jig should at least be flush with the clamping block to ensure that the pocket hole jig works. A panel of the clamping block 10 is provided with a plurality of long waist-shaped through holes 102, and the clamping block 10 is connected with a dust hood 9 at the rear side of the through holes 102, and the dust hood 9 can be externally connected with a vacuumizing device, so that the waste materials in the process of drilling pocket holes can be quickly discharged through the configuration of the dust hood and the vacuumizing device; the clamping block 10 is also fixedly connected with the handle 6, which is connected with the clamping block 10 in a clamping manner, and a hole into which the dust hood 9 extends is formed between the handle 6 and the clamping block 10, and the dust hood 9 is locked by a fastener after extending into the hole, so that the clamping manner is simple to assemble, and the installation of the dust hood is also very convenient; the locking mechanism includes a locking lever 5 fixed in the middle of the base 4, and a first trigger 7 and a second trigger 8 which interact with the locking lever 5 to realize opening and closing, and the first trigger and the second trigger can limit the clamping block. The quick clamping fixture also includes a fixing mechanism for fixing the base 4 on a workbench. The fixing mechanism includes a post 2 connected with the base 4, a bottom block 3 which can be elevatably arranged on the post 2, and a locking knob 1 which is arranged on the bottom block 3. The fixing mechanism adjusts the position appropriately, so that it is suitable for clamping with different workbench thicknesses while being fixed on the workbench.

The quick clamping fixture is ingenious in structural design and convenient to assemble. During working, the pocket hole jig is installed on the clamping block, and the pocket hole jig and the locking mechanism are located on the same side of the wood board, so that clamping, punching and disassembling of the wood board can be quickly realized, and the working efficiency is greatly improved.

When in use, the present utility model will be described with the attached drawings for convenience of understanding.

Referring to FIG. 1, the height of the bottom block 3 is adjusted and the knob 1 is adjusted, so that the quick clamping fixture is fixed on the workbench, and one side of the wood board that needs to be drilled with a pocket hole leans against the back plate 41, and the clamping block 10 is driven to move by the handle 6, so that the pocket hole jig 11 is closely attached to the other side of the wood board, and the clamping is realized by the second trigger 8. After that, the clamping block 10 cannot move, and the drill bit is inserted into the pocket hole jig to drill a pocket hole in the corresponding position of the wood board. The waste material is mainly discharged from the dust hood and the vacuumizing device, and the pocket hole drilling is completed. The first trigger 7 is used to release the wood board. The clamping block 10 is properly moved to take out the wood board, and the remaining waste material falls down due to its own weight. After that, a new wood board can be placed and re-fixed. The clamping is very rapid and the efficiency is high.

The above description is only the preferred embodiment of the present utility model, and is not used to limit the present utility model. For those skilled in the field, the present utility model can be modified and changed in various ways. Any modification, equivalent replacement, improvement, etc. made within the spirit and principle of the present utility model shall be included in the scope of protection of the present utility model.

What is claimed is:

1. A quick clamping fixture for a pocket hole jig, comprising a base (4), a clamping block (10) slidably arranged above the base (4) and a locking mechanism for locking the clamping block (10) from free sliding, wherein a back plate (41) is arranged on one side of the base (4), and the clamping block (10) is provided with an accommodating cavity (101) for accommodating the pocket hole jig (11), and the clamping block (10) slides to clamp wood boards with different thicknesses between the back plate (41) and the pocket hole jig (11).

2. The quick clamping fixture for a pocket hole jig according to claim 1, wherein the back plate (41) is integrally formed with the base (4), and an acting surface of the back plate (41) is coated with a rubber pad.

3. The quick clamping fixture for a pocket hole jig according to claim 1, wherein a height of the pocket hole jig (11) in the accommodating cavity (101) is adjustable, and the acting surface of the pocket hole jig (11) is flush with a side surface of the clamping block (10), or the acting surface of the pocket hole jig (11) protrudes from the clamping block (101).

4. The quick clamping fixture for a pocket hole jig according to claim 1, wherein a panel of the clamping block (10) is provided with a plurality of long waist-shaped through holes (102), and the clamping block (10) is connected with a dust hood (9) at the rear side of the through holes (102), and the dust hood (9) can be externally connected with a vacuumizing device.

5. The quick clamping fixture for a pocket hole jig according to claim 4, wherein the clamping block (10) is also fixedly connected with a handle (6), which is connected with the clamping block (10) in a clamping manner, and a hole into which the dust hood (9) extends is formed between the handle (6) and the clamping block (10), and the dust hood (9) is locked by a fastener after extending into the hole.

6. The quick clamping fixture for a pocket hole jig according to claim 1, wherein the locking mechanism comprises a locking lever (5) fixed in the middle of the base (4), and a first trigger (7) and a second trigger (8) which interact with the locking lever (5) to realize opening and closing.

7. The quick clamping fixture for a pocket hole jig according to claim 1, further comprising a fixing mechanism for fixing the base (4) on a workbench, wherein the fixing mechanism comprises a support post (2) connected with the base (4), a bottom block (3) which can be elevatably arranged on the support post (2), and a locking knob (1) arranged on the bottom block (3).
